(19) United States
(12) Patent Application Publication
(10) Pub. No.: US 2006/0017811 A1
(43) Pub. Date: Jan. 26, 2006

(54) Communication system, electronic apparatus, control apparatus, and computer-readable storage medium

(76) Inventor: Tomoyuki Mizutani, Kawasaki-shi (JP)

Correspondence Address: MORGAN & FINNEGAN, L.L.P., 3 World Financial Center, New York, NY, 10281-2101, US

(21) Appl. No.: 11/233,582

(22) Filed: Sep. 22, 2005

Related U.S. Application Data
(63) Continuation of application No. 09/443,818, filed on Nov. 19, 1999.

(51) Int. Cl. H04N 5/225

(52) U.S. Cl. 348/207.1

(57) ABSTRACT

An object of this invention is to efficiently transmit control information within a short time in a system for controlling a digital camera by a PC through a 1394 bus. To achieve this object, the PC transmits power-off inhibition control data through the 1394 bus before transmitting photographing mode control data to the digital camera. In accordance with this, the digital camera inhibits power-off.

### BACKGROUND OF THE INVENTION

1. Field of the Invention

The present invention relates to a communication system such as a camera control system for controlling the operation of an electronic apparatus such as a digital camera or video camera by transmitting control information from an external control apparatus such as a personal computer (to be referred to as a PC) to the electronic apparatus via a communication medium such as a 1394 serial bus, an electronic apparatus, a control apparatus, and a computer-readable storage medium used in the system and apparatuses.

2. Description of the Related Art

Recently, camera control systems are being realized in which PCs are connected to a digital camera, video camera, and the like using an IEEE 1394 1955 high performance serial bus (to be referred to as a 1394 serial bus) in communication between digital devices.

As a feature of the 1394 serial bus, this 1394 serial bus can transfer large-size data such as image information together with device control data at a high speed. As another feature, the 1394 serial bus can automatically perform reassignment of the ID number as bus reset every time the system connection state changes. A user need not set an ID number for a connection device every time the system connection state changes, unlike a conventional SCSI (Small Computer System Interface). The 1394 serial bus can greatly reduce cumbersome work compared to conventional bus when connecting a portable electronic apparatus such as a digital camera or video camera which is not generally installed.

The IEEE 1394 serial bus technology will be explained.

<<Overview of IEEE-1394 Technology>>

The appearance of digital VTRs and DVDs for home use has been accompanied by the need for support when transferring video and audio data in real time and in great quantity in terms of the information contained. An interface capable of high-speed data transfer is required to transfer audio and video data in real time and load the data in a personal computer or transfer it to another digital device. An interface that has been developed in view of the foregoing is the High-Performance Serial Bus in compliance with IEEE 1394-1995. This bus will be referred to as a “1394 serial bus” below.

FIG. 9 shows an example of a networking system constructed using the 1394 serial bus. This system has devices A, B, C, D, E, F, G, and H. Twisted-pair cables of the 1394 serial bus connect devices A and B; A and C; B and D; D and E; C and F; C and G; and C and H. Examples of the devices A to H are a personal computer, digital VTR, DVD, digital camera, hard disk, and monitor.

The scheme for connecting these devices can be a mixture of a daisy chaining and node branching. A high degree of freedom in making the connections is possible.

Each device has its own ID and by, recognizing one another based upon their IDs, the devices construct one network over an area connected by the 1394 serial bus. By simply interconnecting adjacent devices in succession by one 1394 serial bus cable connected between adjacent devices, each device functions as a relay, and the devices in their entirety construct one network.

When the cable is connected to a device through a plug-and-play function, which is one feature of a 1394 serial bus, device recognition and recognition of the status of a connection is performed automatically.

In the system shown in FIG. 9, devices can be deleted from or added to the network. At such time, bus reset is performed automatically, the network configuration that prevailed thus far is reset, and then a new network is constructed afresh. This function makes it possible to set up a network at any time and for the network to identify the devices constructing it.

Further, 100, 200, and 400 Mbps are available as the data transfer speeds. Devices having higher transfer speeds support lower transfer speeds and are compatible with the devices of lower speed.

The data transfer modes available are an asynchronous transfer mode for transferring asynchronous data such as control signals, and an isochronous transfer mode for transferring isochronous data such as real-time video and audio data. In each cycle (usually 125 μs), the asynchronous data and isochronous data are mixed and transferred in one cycle, while priority is given to transfer of the isochronous data, following transfer of a cycle-start packet (CSP) that indicates the start of the cycle.

FIG. 10 shows the structural components of the 1394 serial bus.

The 1394 serial bus has a layered (hierarchical) structure overall. As shown in FIG. 10, the most basic hardware component is the cable of the 1394 serial bus. The cable has a connector port to which the cable is connected. A physical layer and link layer are the higher layers of the hardware.

In practical terms, the hardware is constituted by interface chips, of which the physical layer performs encoding, connector-related control, and the like, and the link layer performs packet transfer, cycle-time control, and the like.

The firmware includes a transaction layer for managing data to be transferred (transacted) and for issuing instructions such as read and write instructions. Serial-bus management is for managing the status of connections and the ID of each connected device as well as the configuration of the network.

The hardware and firmware make up the essential structure of the 1394 serial bus.

The software constitutes an application layer that differs depending upon the software used. The application layer decides how data is placed on the interface. For example, that is stipulated by a protocol such as an audio-video protocol.

The foregoing sets forth the structure of the 1394 serial bus.

FIG. 11 shows the address space of the 1394 serial bus.

Each device (node) connected to the 1394 serial bus always possesses a 64-bit address that is specific to the node. Storing these addresses in a ROM makes it possible for a node's own address and for the node addresses of other nodes to be recognized at all times. This also makes it possible to perform communication in which the other party is specified.

Addressing a 1394 serial bus is performed in compliance with the standard of IEEE 1212. An address is set using the first 10 bits to specify a bus number and the next six bits to specify a node ID number. The remaining 48 bits constitute address width given to a device and can be used as the specific address space. The last 28 bits of these 48 bits serve as an area for specific data and store information for identifying each device and for designating conditions of use.

The foregoing is an overview of the 1394 serial bus technology.

The features of the 1394 serial bus will now be described in greater detail.

<<Electrical Specifications of 1394 Serial Bus>>

FIG. 12 is a sectional view showing the 1394 serial bus cable.

The connection cable of the 1394 serial bus may be internally provided with a power-supply line in addition to two twisted-pair signal conductors. This makes it possible to supply power to a device not having a power supply and to a device whose voltage has dropped due to failure.

Note, there is a simplified connection cable which does not include a power-supply line. However, such a cable is used to connect specific devices.

According to specifications, the voltage of the power that flows through the power-supply line is 8 to 40 V, and the current is a maximum of 1.5 A DC.

<<DS-Link Coding>>

FIG. 13 is a timing chart useful in describing the DS-link coding scheme of a data transfer format employed in the 1394 serial bus.

The 1394 serial bus employs DS-link (Data/Strobe link) coding. DS-link coding is suited to high-speed serial-data communication. This requires two twisted-pair signal lines. One twisted-pair mainly sends data, and the other sends a strobe signal.

On the receiving side, a clock can be reproduced by taking the exclusive-OR between the transmitted data and strobe.

Using the DS-link coding scheme is advantageous in that transmission efficiency is higher in comparison with other serial-data transmission schemes and in that the scale of the controller LSI circuitry can be reduced because a PLL circuit is unnecessary. Furthermore, when there is no data to be transferred, there is no need to send information indicative of the idle state. Accordingly, by placing the transceiver circuit of each device in the sleep state, less power is consumed.

<<Bus-Reset Sequence>>

In the 1394 serial bus, a node ID is assigned to each connected device (node) so that the devices may be recognized as constituting a network.

If there is a change in the network configuration, e.g., a change caused by increasing or decreasing the number of nodes by plugging in or unplugging a node or by turning a node power supply on or off, recognition of the new network configuration becomes necessary. At such time, each node that has sensed the change transmits a bus-reset signal over the bus, and a mode in which the new network configuration recognized is established.

The method of sensing the change involves sensing a change in bias voltage on the board of the 1394 port.

Upon being sent a bus-reset signal from a certain node, the physical layer of each node receives the bus-reset signal and, at the same time, reports occurrence of the bus reset to the link layer and sends the bus-reset signal to the other nodes. After all nodes have eventually sensed the bus-reset signal, bus reset is activated.

Bus reset can also be activated by hardware detection of cable plugging/unplugging and of network anomalies and by issuing an instruction directly to the physical layer by host control from the protocol.

When bus reset is activated, data transfer is suspended temporarily and is resumed on the basis of the new network configuration after the completion of reset.

The foregoing is a description of the bus-reset sequence.

<<Node-ID Decision Sequence>>

In order for each of the nodes to construct the new network configuration after bus reset, an operation for assigning an ID to each node begins. The usual sequence from bus reset to determination of node IDs will be described with reference to the flow charts of FIGS. 21, 22, and 23.

The flow chart of FIG. 21 shows a series of bus operations from occurrence of bus reset to determination of node IDs and data transfer.

First, occurrence of bus reset within the network is monitored constantly in step S101. Control proceeds to step S102 when bus reset occurs as a result of, e.g., a node power supply being turned on or off.

In step S102, a declaration of parent-child relationship is made between directly connected nodes in order to ascertain the status of the connections of the new network from reset state of the network. If the parent-child relationships have been determined between all nodes in step S103, one root is decided in step S104. Until the parent-child relationships are determined between all nodes, the declaration of the parent-child relationship in step S102 is repeated, and a root is not decided.

When a root is decided in step S104, node-ID setting operation for providing each node with an ID is carried out in step S105. Node IDs are set in a predetermined node sequence, and the setting operation is performed repeatedly until all nodes have been provided with IDs. When the setting of IDs for all nodes is eventually completed in step S106, the new network configuration will have been recognized at all nodes, and a state will be attained in which data transfer between nodes can be carried out in step S107. Data transfer thus begins.

When the state in step S107 is attained, a transition is again made to the mode in which the occurrence of bus reset is monitored. If bus reset occurs, the setting operation from step S101 to step S106 is repeated.

The foregoing is a description of the flow chart in FIG. 21. The portion of this flow chart from bus reset to root determination and the sequence from the conclusion of root determination to the end of ID setting are shown in FIGS. 22 and 23, respectively, when expressed more precisely in flow chart form.

In FIG. 22, when bus reset occurs in step S201, the network configuration is reset temporarily. It should be noted that occurrence of bus reset is constantly monitored in step S201. Next, in step S202, a flag indicative of a leaf node is set for each device as the first step of an operation for re-recognition of the topology of the reset network. Furthermore, in step S203, each device determines how many of its own ports have been connected to other devices.

This is followed by step S204, in which the number of undefined ports (ports for which the parent-child relationship has not been determined) is checked, based upon the number of ports obtained in step S203, in order to being the ensuing declaration of parent-child relationship. After bus reset, the number of ports will be equal to the number of undefined ports. However, as parent-child relationships are decided, the number of undefined ports sensed in step S204 changes.

Immediately after bus reset, nodes which can make declarations of parent-child relationship first are limited to leafs. A node can ascertain that it is a leaf from examining the number of connected ports in step S203. The leaf declares with respect to a node connected to it that “This node is the child, and the other node is the parent” in step S205. This operation then ends.

With regard to a node whose number of connected ports is found to be plural in step S203, meaning that the node has been identified as a branch point, the number of undefined ports after bus reset is found to be greater than 1 in step S204. As a result, control proceeds to step S206. First, a flag indicative of a branch is set in step S206. This is followed by step S207, in which the node waits for acceptance of “Parent” in the declaration of the parent-child relationship from a leaf.

The leaf makes the declaration of the parent-child relationship, and the branch that received this in step S207 checks the number of undefined ports in step S204. If the number of undefined ports is 1, it is possible to declare “The node is a child” in step S205 to the node connected to the remaining port. If, from the second time onward, there are two or more branches when the number of undefined ports is checked in step S204, the node again waits in order to accept “Parent” from a leaf or from another branch in step S207.

Finally, when any one branch or, in exceptional cases, a leaf (because the node did not operate quickly enough to issue the “Child” declaration) indicates zero as the number of undefined ports in step S204, the declarations of the parent-child relationship for the entire network end as a result. The sole node for which the number of undefined ports has become zero (i.e., for which all of the ports have been determined to be parent ports) has a root flag set for it in step S208, and this node is recognized as a root in step S209.

Thus ends the processing of FIG. 22 from bus reset to declaration of the parent-child relationships between all nodes of the network.

The flow chart of FIG. 23 will now be described.

In the sequence up to FIG. 22, information on the flags of all nodes that indicates whether a node is a leaf, branch, or root is set. The nodes are classified on the basis of this information in step S301.

In the operation of assigning an ID to each node, the node for which an ID can be set first is a leaf. The setting of IDs is performed in the order of leaf→branch→root starting from smaller numbers (from a node number of 0).

The number N (where N is a natural number) of leafs that exist in the network is set in step S302. Each leaf then requests the root to be given an ID in step S303. In a case where there are a plurality of requests, the root performs arbitration (an operation to decide on any one node) in step S304. An ID number is assigned to the one winning node and the losing nodes are so notified in step S305.

A leaf whose acquisition of an ID ended in failure in step S306 issues an ID request again. The foregoing operation is then repeated. A leaf that has acquired an ID transfers the ID information of this node to all nodes by a broadcast in step S307.

When the broadcast of the ID information of one node ends, the number of remaining leafs is reduced by one in step S308. If the number of remaining leafs is found to be one or more in step S309, operation is repeated from the ID request in step S303. When all leafs have finally broadcast ID information, N becomes equal to 0 in step S309, and control then proceeds to the setting of branch IDs.

The setting of branch IDs is performed in a manner similar to that for leafs.

That is, the number M (where M is a natural number) of branches that exist in the network is set in step S310. Each branch then requests the root to be given an ID in step S311. In response, the root performs arbitration in step S312 and assigns the winning branch a number in order starting from smaller numbers that follow those already assigned to leafs.

The root notifies a branch that has issued a request of its ID number or of the fact that the request failed in step S313. A branch whose acquisition of an ID ended in failure in step S314 issues an ID request again. The foregoing operation is then repeated. A branch that has acquired an ID transfers the ID information of this node to all nodes by a broadcast in step S315.

When the broadcast of the ID information of one node ends, the number of remaining branches is reduced by one in step S316. If the number of remaining branches is found to be one or more in step S317, operation is repeated from the ID request in step S311. This operation is carried out until all branches eventually broadcast ID information. When all branches acquire node IDs, M becomes equal to 0 in step S317, and the mode for acquiring branch IDs ends.

When processing thus far ends, a node which has not yet acquired ID information is a root only. The root sets the largest unassigned number as its own ID number in step S318 and broadcasts the root ID information in step S319.

Thus, as shown in FIG. 23, the sequence up to the setting of IDs for all nodes following the parent-child relationship determinations ends.

Next, operation in an actual network shown in FIG. 14 will be described as one example.

The hierarchical structure described in FIG. 14 is such that nodes A and C are directly connected as inferior to node B (the root), node D is directly connected as inferior to node C, and nodes E and F are directly connected as inferior to node D. This hierarchical structure and a sequence for determining the root node and node IDs will be described below.

In order to recognize the connection status of each node after bus reset, a declaration of the parent-child relationship is made between the ports at which the nodes are directly connected. A parent has a superior status in the hierarchical structure and the child has an inferior status. In FIG. 14, the node that issues the declaration on parent-child relationship first following bus reset is node A. Basically, declaration of the parent-child relationship can be issued from a node (to be referred to as a leaf) having a connection at only one port. The node can ascertain this from the fact that it has only one port connected. In this way, the node recognizes that it is at a terminus of the network and the parent-child relationships are determined one after another starting from those terminus nodes that go into operation earliest.

Thus, the port on the side (node A of the nodes A and B) that has issued the declaration of the parent-child relationship is set as a child port, and the port on the side of the other party (node B) is set as a parent port. Accordingly, it is determined that nodes A and B are child-parent related, nodes E and D are child-parent related, and nodes F and D are child-parent related, respectively.

Nodes one layer higher have a plurality of connected ports. These nodes are referred to as branches. Among these nodes, those that have received declarations of the parent-child relationship from other nodes issue declarations of the parent-child relationship in succession and to their superiors. In FIG. 14, after node D is determined to be the parent in the D-E and D-F relationships, it issues the declaration of the parent-child relationship with respect to node C. As a result, the relationship determined between nodes D and C is child-parent, respectively.

Node C, which has received the declaration of parent-child relationship from node D, issues a declaration of parent-child relationship with regard to node B, which is connected to the other port of node C. As a result, it is determined that the relationship between nodes C and B is child-parent, respectively.

Thus, the hierarchical structure of FIG. 14 is constructed, and node B, which is the parent to all connected nodes, is eventually determined to be the root node. Only one root node can exist in one network configuration.

Node B in FIG. 14 has been determined to be the root node. If node B, which has received the declaration of parent-child relationship from node A, issues its declaration of parent-child relationship to other nodes at an early timing, there is the possibility that the root node will shift to another node. In other words, depending upon the timing at which the declaration is transmitted, any node can become the root node, and in one and the same network configuration, the root node is not always fixed.

After the root node is decided, a transition is made to a mode for deciding the node IDs. In this mode, all nodes communicate their own node IDs to all other nodes. This is a broadcast function.

Node's own ID information includes its own node number, information on the position at which it has been connected, the number of ports it possesses, the number of ports connected, or information on the parent-child relationship of each port.

The sequence for assigning node ID numbers can be started from nodes (leafs) having only one of their ports connected. Node numbers 0, 1, 2, . . . are assigned to these nodes in regular order.

A node that has acquired a node ID broadcasts information inclusive of the node number to each of the other nodes. As a result, this ID number is recognized as being “already assigned”.

If all leafs have finished acquiring their own node IDs, then operation shifts to branches so that node ID numbers are assigned to branch nodes after leaf nodes. In a manner similar to that of the leafs, branches to which node ID numbers have been assigned broadcast their node ID information in succession. Finally, the root node broadcasts its own ID information. That is, the root always possesses the largest node ID number.

Thus, the assignment of the node IDs of the entire hierarchical structure ends, the network is reconstructed, and the bus initialization operation is completed.

<<Arbitration>>

With a 1394 serial bus, arbitration for bus access is always carried out before data transfer. The 1394 serial bus is a logical but-type network. In other words, each separately connected device relays a transferred signal, thereby transmitting the same signal to all devices in the network. Consequently, arbitration is necessary to prevent collision of packets. As a result, only one node can perform a transfer at a certain time.

FIGS. 15A and 15B are diagrams useful in describing arbitration, in which FIG. 15A shows a situation when bus access is requested, and FIG. 15B shows a situation in which bus access is allows or refused in response to a request. Arbitration will now be described with reference to these diagrams.

When arbitration starts, one or a plurality of nodes each sends the parent nodes a request for bus access privilege. In FIG. 15A, nodes C and F are the nodes issuing bus access requests.

A parent node (node A in FIG. 15A) that has received a bus access request sends (relays) the request to its parent node. This request eventually arrives at the root that performs arbitration. Upon receiving the bus access request, the root node decides which node should be granted access to the bus. Such arbitration is performed solely by the root node. The node that has won the arbitration is granted access to the bus. FIG. 15B shows that bus access has been granted to node C and denied to node F.

A DP (Data Prefix) is sent to the node that lost the arbitration, thereby informing this node of refusal. The bus access request from the refused node waits for the next arbitration.

The node that won the arbitration and was granted bus access can start transferring data.

The flow of arbitration will be described with reference to the flow chart of FIG. 24.

In order for a node to start data transfer, it is necessary that the bus be in an idle state. In order to recognize that the bus is currently idle following the end of a data transfer performed previously, each node judges that its own transfer can start based upon elapse of a predetermined idle-time gap length (e.g., a subaction gap) set separately in each transfer mode.

First, in step S401, it is determined whether the predetermined gap length has been obtained. The gap length conforms to the data to be transferred, which is asynchronous data or isochronous data. As long as the predetermined gap length is not obtained, bus access needed to begin a transfer cannot be requested. Accordingly, the node waits until the predetermined gap length is obtained.

If the predetermined gap length is obtained in step S401, it is determined in step S402 whether there is data to be transferred. If there is such data, then, in step S403, the root is sent a bus access request so as to reserve the bus for the transfer. The signal representing the bus access request eventually arrives at the root while being relayed through each device in the network, as shown in FIG. 15A.

If it is found in step S402 that there is no data to be transferred, the node stands by. Next, if the root receives one or more bus access requests from step S403 in step S404, then, in step S405, the root checks the number of nodes that issued access requests. If it is found in step S405 that the number of nodes is equal to 1 (i.e., that one node issues a bus access request), then this node is provided with the bus access that will be allowed next.

If it is found in step S405 that the number of nodes is greater than 1 (i.e., that a plurality of nodes issued bus access requests), then the root performs arbitration in step S406 to decide one node that is to be granted bus access. This arbitration operation assures that all devices have fair access to the bus and does not grant access only to the same node every time.

This is followed by step S407, in which the one node granted bus access by arbitration performed in step S406 by the root and the other nodes that lost the arbitration are separated from the plurality of nodes that issued the bus access requests. Next, in step S408, the root sends an enable signal to the one node that was granted bus access by arbitration or to a node that obtained bus access without arbitration because it was found in step S405 that the number of nodes requesting access is equal to one. The node that has obtained the enable signal immediately starts transferring data (a packet) that is to be transferred.

A node that lost the arbitration in step S406 and was not granted bus access is sent the DP (Data Prefix) packet, which is indicative of failed arbitration, by the root in step S409. Upon receiving this packet, the node issues the bus access request again in order to perform a transfer. As a result, control returns to step S401, and the node stands by until the predetermined gap length is obtained.

<<Asynchronous Transfer>>

Asynchronous transfer is transfer that is not synchronous. FIG. 16 shows the state of temporal transition in asynchronous transfer. An initial subaction gap in FIG. 16 indicates the idle state of the bus. At the moment, idle time attains a fixed value, a node wishing to perform a transfer judges that the bus can be used and executes arbitration for bus acquisition.

When bus access is granted by arbitration, transfer of data is executed in a packet format. After data is transferred, a node that has received the data responds by sending back acknowledgement “ack” (a code sent back to acknowledge reception) regarding the transferred data, or by sending a response packet, after a short gap referred to as an “ack gap”.

Here “ack” comprises 4-bit information and a 4-bit checksum. Further, “ack” includes information such as success, busy state, pending state, and the like, and is sent back immediately to the node that was the source of the transmission.

FIG. 17 shows an example of the packet format for asynchronous transfer.

A packet has a header portion in addition to a data field and data CRC that is for error correction. As shown in FIG. 17, a target node ID, source node ID, transfer data length, and various codes are written in the header in order to be transferred.

Asynchronous transfer is one-to-one communication from one node to another. A packet that has been transferred from a node that was the source of the transfer is delivered to each node in the network. However, since addresses other that a node's own address are ignored, only the one node at the destination is read in.

<<Isochronous Transfer>>

Isochronous transfer is transfer that is synchronous. Isochronous transfer, which can be said to be the most significant feature of the 1394 serial bus, is a transfer mode suited to the transfer of data that requires real-time transfer, such as multimedia data composed of video data and audio data.

Whereas asynchronous transfer is one-to-one transfer, isochronous transfer is transfer from one node that is the source of the transfer to all other nodes by means of a broadcast function.

FIG. 18 shows the state of temporal transition in isochronous transfer.

Isochronous transfer is executed over a bus at fixed times. The time interval is referred to as an “isochronous cycle”, the duration of which is 125 μs. The role of a cycle-start packet is to indicate the starting time of each cycle and to perform a time adjustment for each node.

A node referred to as the “cycle master” transmits the cycle-start packet. The cycle master transmits the cycle-start packet, which informs of the start of the present cycle, upon elapse of a predetermined idle time (the subaction gap) following the end of transfer in the immediately preceding cycle. The time interval in which the cycle-start packet is transmitted is 125 μs.

As shown in FIG. 18, various packets can be transferred in one cycle upon being distinguished from one another by assigning channel IDs to them in the manner of channel A, channel B, and channel C. This makes it possible to perform real-time transfer among a plurality of nodes simultaneously. In addition, a receiving node reads in only the data of the ID channel which it itself desires. The channel ID does not represent the address of the transmission destination but merely provides a physical number in regard to data. Accordingly, in transmission of a certain packet, transfer is performed by broadcast in such a manner that the packet is delivered from the one transmission-source node to all of the other nodes.

As in the manner of asynchronous transfer, arbitration is carried out before transmission of a packet in isochronous transfer. However, since this is not one-to-one communication as in asynchronous transfer, “ack” (the code sent back to acknowledge reception) does not exist in isochronous transfer.

Further, the “iso gaps” (isochronous gaps) shown in FIG. 18 represent idle intervals necessary to verify that the bus is idle before an isochronous transfer is performed. When the predetermined idle time elapses, the node wishing to perform the isochronous transfer judges that the bus is idle. As a result, arbitration in advance of transfer can be executed.

FIG. 19 shows an example of the packet format for isochronous transfer.

Each of the various packets classified by their channels has a header portion in addition to a data field and data CRC that is for error correction. As shown in FIG. 19, transfer data length, channel number, various codes, and an error correction header CRC are written in the header in order to be transferred.

<<Bus Cycle>>

Transfer over an actual 1394 serial bus can be a mixture of isochronous transfer and asynchronous transfer. FIG. 20 shows the temporal transition of transfer on a bus over which isochronous transfer and asynchronous transfer are mixed.

Isochronous transfer is performed at a priority higher than that of asynchronous transfer. The reason for this is that after a cycle-start packet is issued, isochronous transfer can be started at a gap length (isochronous gap or “iso gap”) that is shorter than the gap length (subaction gap) of an idle interval necessary to start asynchronous transfer. Accordingly, priority is given to isochronous transfer over asynchronous transfer.

In the usual bus cycle shown in FIG. 20, the cycle-start packet is transferred from the cycle master to each node at the start of cycle #m. As a result, a time adjustment is carried out at each node, a node that is to perform isochronous transfer carries out arbitration after waiting the predetermined idle time (isochronous gap) and then enters the packet transfer phase. In FIG. 20, channel e, channel s, and channel k are transferred isochronously in the order mentioned.

After the operation from arbitration to packet transfer has been repeated a number of times equal to the number of channels given and all isochronous transfers in cycle #m end, asynchronous transfer can be carried out.

As a result of idle time becoming equal to the subaction gap that makes asynchronous transfer possible, a node that desires to perform an asynchronous transfer judges that a transition has been made to execution of arbitration. However, asynchronous transfers can be made only in a case where the subaction gap for activating asynchronous transfer is obtained in a period of time from the end of an isochronous transfer to the moment (cycle synch) at which the next cycle-start packet is to be transferred.

In the cycle #m in FIG. 20, three channels of isochronous transfers and the subsequent asynchronous transfers (inclusive of ack) transfer two packets (packet 1 and packet 2). Following the asynchronous packet 2, the time (cycle synch) at which cycle #m+1 is to start arrives. As a result, transfer in cycle #m ends at this point.

However, if the time (cycle synch) at which the next cycle-start packet is to be transmitted has arrived during asynchronous or isochronous transfer operation, the transfer operation is not forcibly interrupted, and the cycle-start packet of the next cycle is transmitted after waiting the idle time that follows the end of transfer. IN other words, when the first cycle continues for more 125 μs, the next cycle is made correspondingly shorter than the standard 125 μs. That is, the isochronous cycle can be made longer or shorter than the reference 125 μs.

If isochronous transfer is necessary every cycle in order to maintain real-time transfer, then it is executed without fail. As a result of cycle time being shortened, there are also occasions where asynchronous transfer is held over to the ensuring cycle. Such delay information also is managed by the cycle master.

FIG. 25 shows a conventional camera control system using a 1394 serial bus.

In FIG. 25, reference numeral 1 denotes a 1394 serial bus cable connected to a digital camera 100 and PC 200.

The digital camera 100 comprises an image sensing unit 101 for photoelectrically converting an image of an object to be photographed, A/D converter 102, image processor 103, D/A converter 104, an EVF (Electronic ViewFinder) 105 for monitoring an image, encoding/decoding circuit 106 for encoding/decoding image data, recording/playback unit 107 for recording/playing back image data, 1394 serial bus I/F 108, power supply unit 109, operation unit 110, and system controller 111 for controlling the respective units.

The PC 200 comprises a display 201, hard disk 202, memory 203, MPU 204 serving as an arithmetic unit, PCI bus 205, operation unit 206 such as a keyboard or mouse, 1394 serial bus I/F 207, power supply unit 208, and timer 209.

Operation of setting, e.g., a monochrome photographing mode in the digital camera 100 by the PC 200 in this system will be explained with reference to FIGS. 26, 27, and 28.

FIG. 26 shows the operation sequence of the PC 200 when a user inputs an execution command for a monochrome photographing mode setting program through the operation unit 206.

If the user inputs an execution command for the monochrome photographing mode setting program through the operation unit 206 in step S3001, the PC 200 displays character information “The monochrome photographing mode is being set” on the display 201 in step S3002.

The MPU 204 loads monochrome photographing mode control data from the hard disk 202 to the memory 203 in step S3003, and executes a control data output subroutine in step S3004 in order to output monochrome photographing mode control data from the 1394 serial bus I/F 207.

FIG. 27 shows the operation sequence of the control data output subroutine in step S3004.

In order to output control data from the PC 200 to the digital camera 100, the PC 200 asynchronously transfers a data write request packet like the one shown in FIG. 17 to the digital camera 100 through the 1394 serial bus cable 1.

More specifically, the PC 200 outputs a data write request packet from the 1394 serial bus I/F 207 to the 1394 serial bus I/F 108 in step S3101, and starts the timer 209 in step S3102. The timer 209 detects a communication error caused by, e.g., power-off of the digital camera 100.

The PC 200 checks in step S3103 whether the 1394 serial bus I/F 207 receives a write response packet like the one shown in FIG. 29 from the 1394 serial bus I/F 108. If NO in step S3103, the PC 200 determines in step S3104 whether the timer 209 counts the time-out period. If NO in step S3104, the PC 200 returns to step S3103.

If YES in step S3104, the PC 200 checks the power supply state of the digital camera 100 in step S3105. If the digital camera 100 is ON, the PC 200 returns to the step S3101 to restart the sequence. If the digital camera 100 is OFF, the PC 200 displays character information “Turn on the digital camera” on the display 201 in step S3106 to prompt the user to turn on the digital camera 100. The PC 200 checks the power supply state of the digital camera 100 again in step S3107. If the digital camera 100 is OFF, the PC 200 repeats step S3107.

If the user turns on the digital camera 100, bus reset occurs in the 1394 serial bus I/F 207 in step S3108. The PC 200 returns to step S3101 to restart the sequence.

If YES in step S3103, the PC 200 checks in step S3109 a response status representing whether a write of control data is successful. If the write fails, the PC 200 returns to step S3101 to restart the sequence. If the write is successful, the control data output subroutine ends, and the PC 200 returns to the main routine in FIG. 26.

After monochrome photographing mode control data is output, the PC 200 displays character information “Setting of the monochrome photographing mode is completed” on the display 201 in step S3005, and the main routine ends.

The operation sequence of the digital camera 100 when a is input to the 1394 serial bus I/F 108 will be explained in FIG. 28.

If the 1394 serial bus I/F 108 receives a data write request packet in step S3201, the system controller 111 receives and interprets monochrome photographing mode control data from the 1394 serial bus I/F 108 in step S3202 and outputs a monochrome image processing command to the image processor 103 in step S3203.

In step S3204, the system controller 111 outputs a write response packet from the 1394 serial bus I/F 108 to the 1394 serial bus I/F 207.

Since cameras such as a digital camera and video camera are portable, they are generally of a battery-driven type. If the battery discharges by a predetermined amount or more, the camera is turned off. If the camera is not operated for a predetermined time or more in order to minimize the power consumption of the battery, the camera is automatically turned off.

If the camera is turned off while transmitting control information, the camera control system obtained by connecting the camera and PC through the 1394 serial bus must transmit the entire control information again after the camera is turned on again. The system undesirably spends a long time for communication operation.

### SUMMARY OF THE INVENTION

The present invention has been made to overcome the conventional drawbacks, and has as its object to efficiently transmit control information within a short time in a communication system such as a camera control system obtained by connecting a camera and PC through a 1394 serial bus.

To achieve the above object, a communication system according to the present invention comprises an electronic apparatus having first communication means and a control apparatus having second communication means connected to the first communication means through a communication medium, the control apparatus having transmission means for transmitting, through the communication medium, control information for causing the electronic apparatus to execute a predetermined operation, wherein the transmission means transmits control information for inhibiting the electronic apparatus from being turned off.

Another communication system according to the present invention comprises an electronic apparatus having first communication means and a control apparatus having second communication means connected to the first communication means through a communication medium, the control apparatus having transmission means for transmitting, through the communication medium, control information for causing the electronic apparatus to execute a predetermined operation, wherein the control apparatus has power supply means for supplying power for the electronic apparatus to the electronic apparatus through the communication medium, the transmission means transmits power switching control information, and the electronic apparatus comprises switching means for switching between electronic apparatus' own power and the power to be supplied on the basis of the switching control information.

An electronic apparatus according to the present invention comprises communication means connected to a control apparatus through a communication medium, control means for controlling operation on the basis of control information transmitted from the control apparatus through the communication medium, and inhibition means for inhibiting power-off on the basis of power-off inhibition control information transmitted from the control apparatus through the communication medium.

Another electronic apparatus according to the present invention comprises communication means connected to a control apparatus through a communication medium, control means for controlling operation on the basis of control information transmitted from the control apparatus through the communication medium, and switching means for switching between electronic apparatus' own power and power supplied from the control apparatus through the communication medium on the basis of switching control information transmitted from the control apparatus through the communication medium.

A control apparatus according to the present invention comprises communication means connected to an electronic apparatus through a communication medium, and transmission means for transmitting, through the communication medium, control information for controlling operation of the electronic apparatus and control information for inhibiting power-off of the electronic apparatus.

Another control apparatus according to the present invention comprises communication means connected to an electronic apparatus through a communication medium, power supply means for supplying power to the electronic apparatus, and transmission means for transmitting, through the communication medium, control information for controlling operation of the electronic apparatus and power switching control information.

A storage medium according to the present invention stores a program for executing processing of transmitting, to an electronic apparatus through a communication medium, control information for controlling operation of the electronic apparatus and control information for inhibiting power-off of the electronic apparatus.

Another storage medium according to the present invention stores a program for executing processing of transmitting control information for controlling operation of an electronic apparatus to the electronic apparatus through a communication medium, processing of supplying power for the electronic apparatus to the electronic apparatus through the communication medium, and processing of transmitting power switching control information to the electronic apparatus through the communication medium.

Still another storage medium according to the present invention stores a program for executing processing of controlling operation on the basis of control information transmitted from a control apparatus through a communication medium, and processing of inhibiting power-off on the basis of power-off inhibition control information transmitted from the control apparatus through the communication medium.

Other objects and advantages besides those discussed above shall be apparent to those skilled in the art from the description of a preferred embodiment of the invention which follows. In the description, reference is made to accompanying drawings, which form a part hereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a block diagram showing the configuration of a camera control system using a 1394 serial bus according to the first embodiment of the present invention;

FIG. 2 is a flow chart showing the operation sequence of a PC 200 when a user inputs an execution command for a monochrome photographing mode setting program through an operation unit 206 in FIG. 1;

FIG. 3 is a flow chart showing a storage data input operation sequence in step S3305 of FIG. 2;

FIG. 4 is a flow chart showing the operation sequence of a digital camera 300 when data is input to a 1394 serial bus I/F 108 in FIG. 1;

FIG. 5 is a flow chart showing a control operation execution sequence in steps S3503 and S3511 of FIG. 4;

FIG. 6 is a block diagram showing the configuration of a camera control system using a 1394 serial bus according to the second embodiment of the present invention;

FIG. 7 is a flow chart showing the operation sequence of a PC 400 when a user inputs an execution command for a monochrome photographing mode setting program through an operation unit 206 in FIG. 6;

FIG. 8 is a flow chart showing the operation sequence of a digital camera 500 when data is input to a 1394 serial bus I/F 108 in FIG. 6;

FIG. 9 is a block diagram showing a network system using a 1394 serial bus;

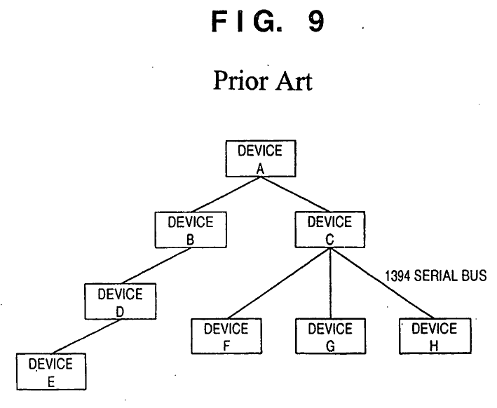

FIG. 10 is a block diagram showing the structural components of the 1394 serial bus;

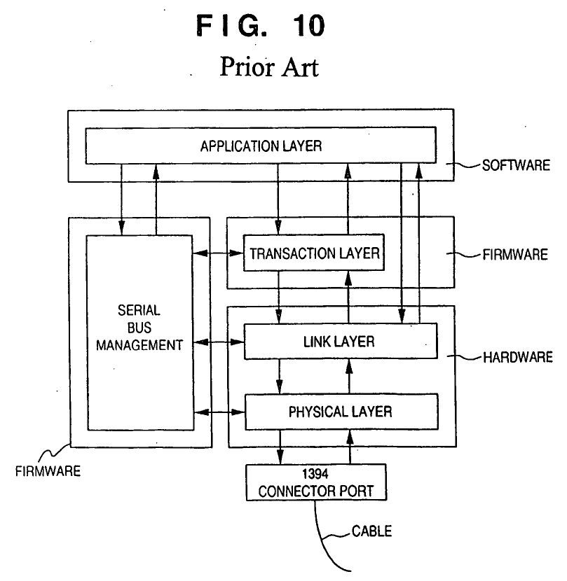

FIG. 11 is a view showing the address space of the 1394 serial bus;

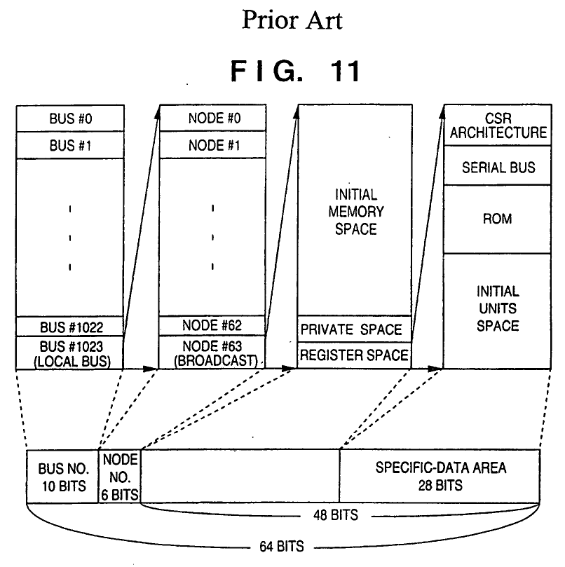

FIG. 12 is a sectional view showing the 1394 serial bus cable;

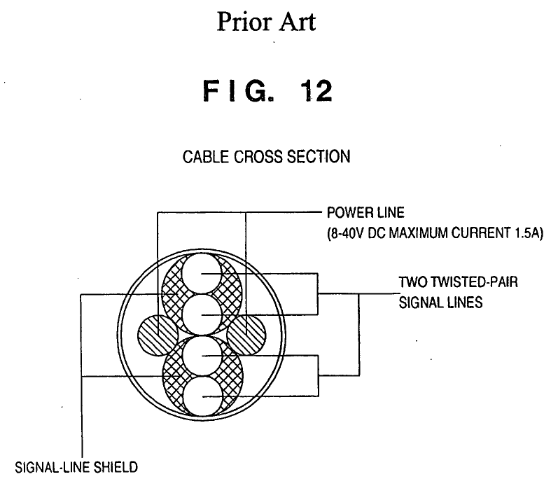

FIG. 13 is a timing chart showing the data transfer format in the 1394 serial bus;

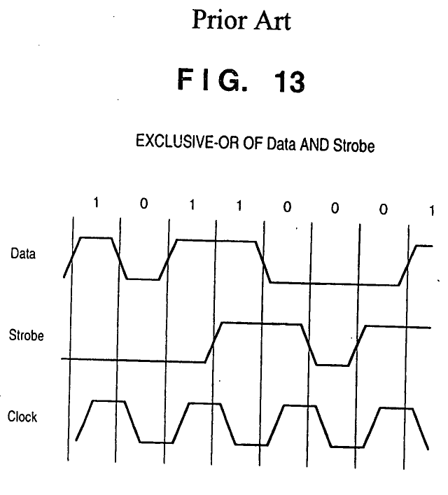

FIG. 14 is a block diagram for explaining the operation of the network using the 1394 serial bus;

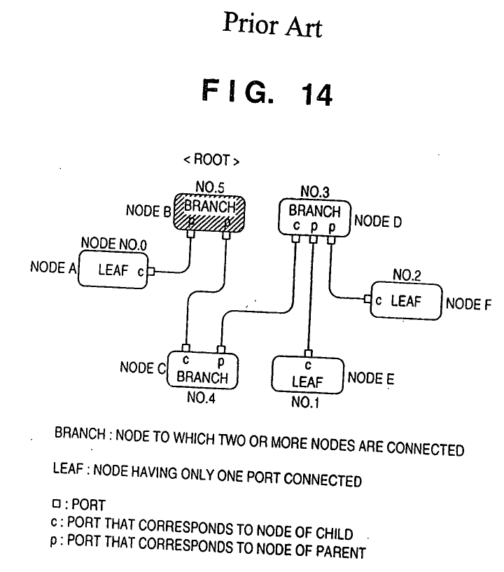

FIGS. 15A and 15B are block diagrams for explaining arbitration in the 1394 serial bus;

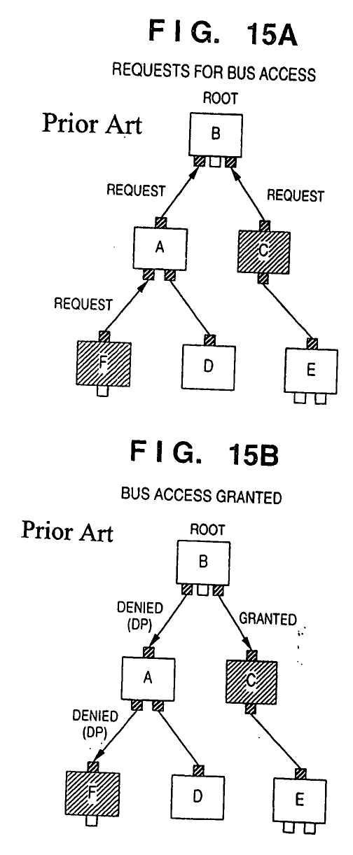

FIG. 16 is a timing chart showing the state of temporal transition in asynchronous transfer;

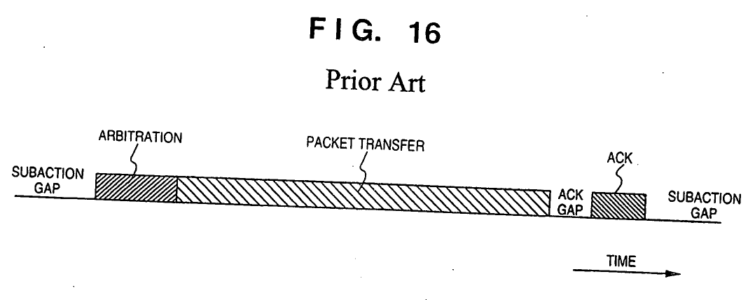

FIG. 17 is a view showing an example of the packet format for asynchronous transfer;

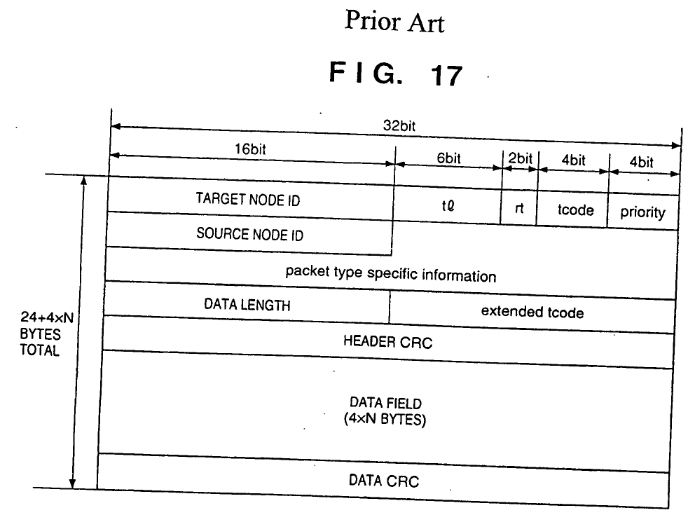

FIG. 18 is a timing chart showing the state of temporal transition in isochronous transfer;

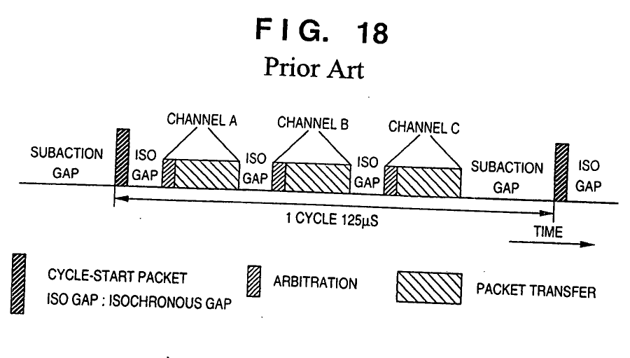

FIG. 19 is a view showing an example of the packet format for isochronous transfer;

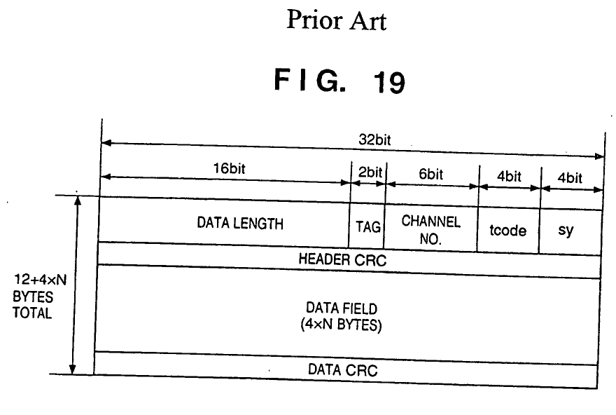

FIG. 20 is a timing chart showing the bus cycle;

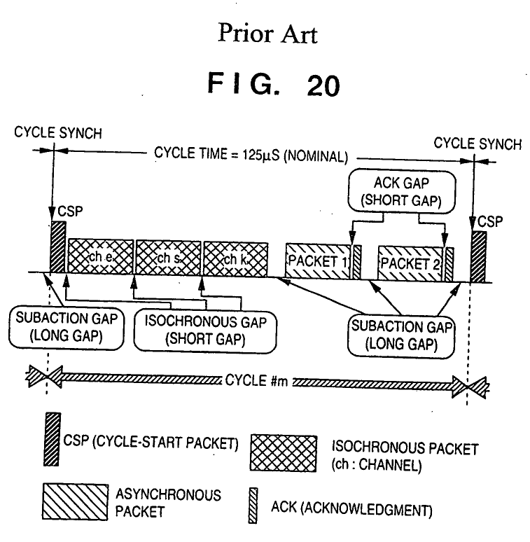

FIG. 21 is a flow chart showing bus operation from bus reset to data transfer;

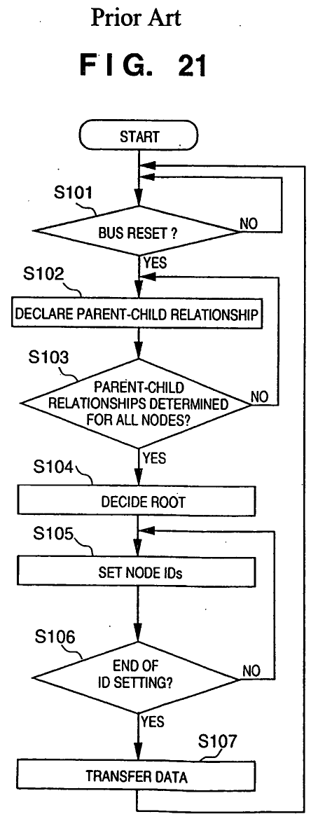

FIG. 22 is a flow chart showing the bus operation in more detail;

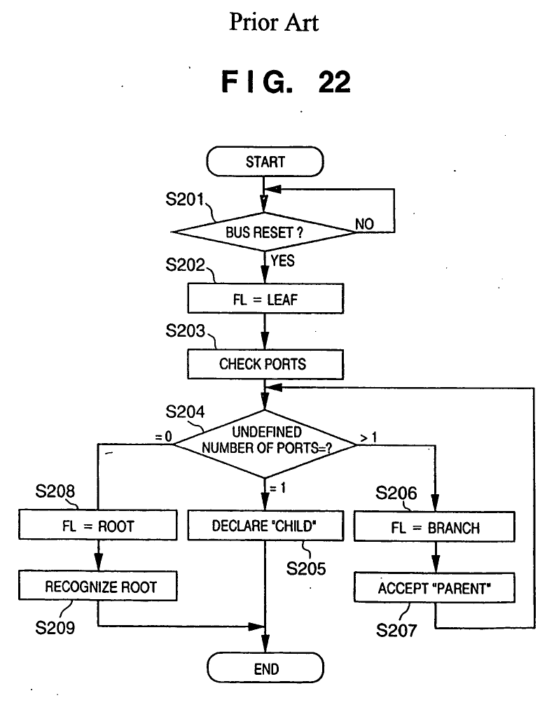

FIG. 23 is a flow chart showing the subsequent bus operation;

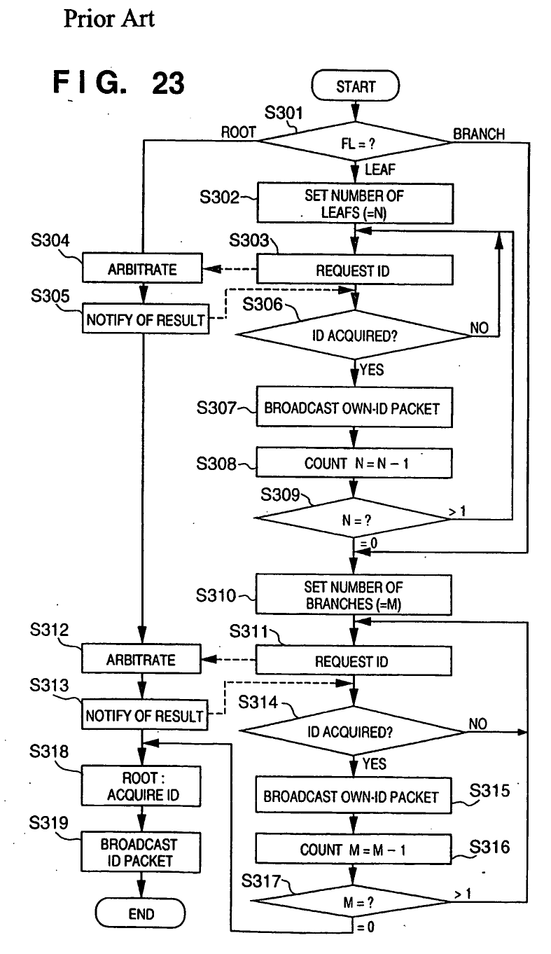

FIG. 24 is a flow chart showing arbitration processing;

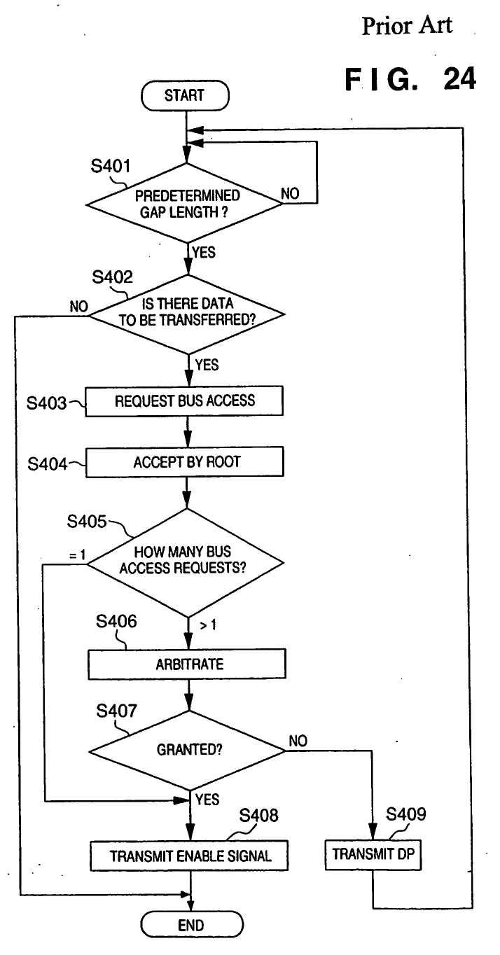

FIG. 25 is a block diagram showing the configuration of a conventional camera control system using a 1394 serial bus;

FIG. 26 is a flow chart showing the operation sequence of a PC 200 when a user inputs an execution command for a monochrome photographing mode setting program through an operation unit 206 in FIG. 25;

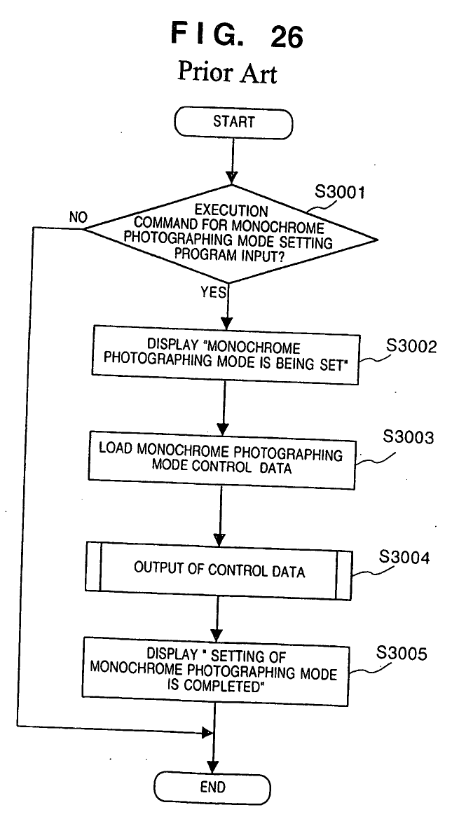

FIG. 27 is a flow chart showing a control data output operation sequence in step S3004 of FIG. 26;

FIG. 28 is a flow chart showing the operation sequence of a digital camera 100 when data is input to a 1394 serial bus I/F 108 in FIG. 25;

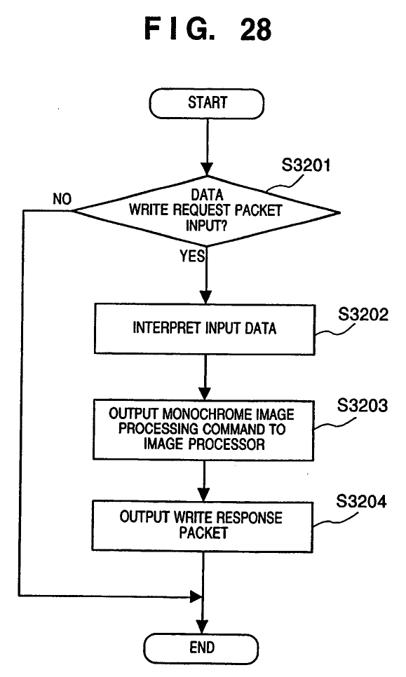

FIG. 29 is a view showing the format of a write response packet for asynchronous transfer in the 1394 serial bus;

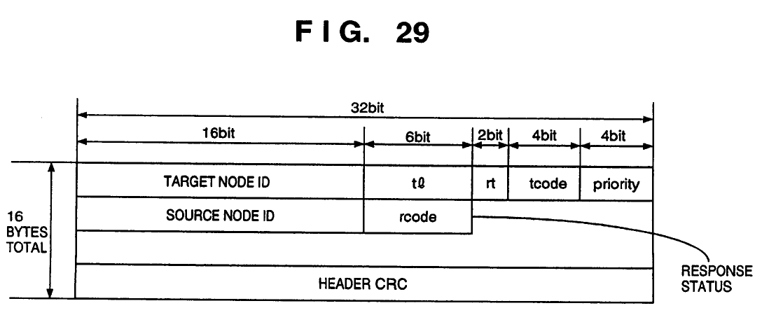

FIG. 30 is a view showing the format of a read request packet for asynchronous transfer in the 1394 serial bus; and

FIG. 31 is a view showing the format of a read response packet for asynchronous transfer in the 1394 serial bus.

### DETAILED DESCRIPTION OF THE PREFERRED EMBODIMENTS

Preferred embodiments of the present invention will be described below with reference to the accompanying drawings.

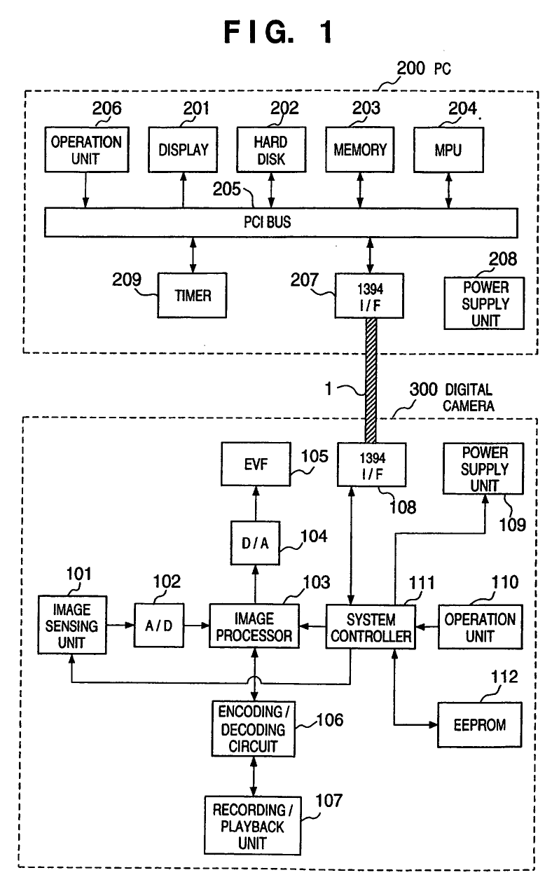

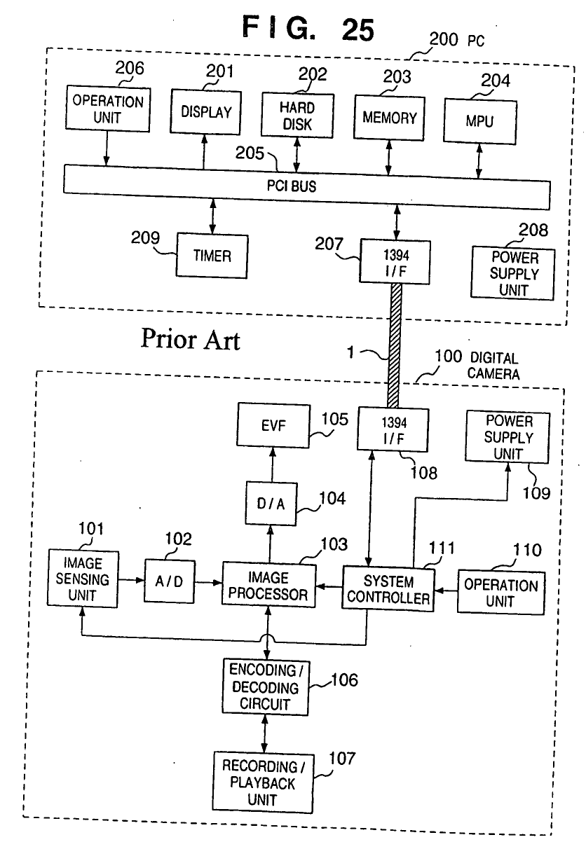

FIG. 1 shows the configuration of a camera control system using a 1394 serial bus according to the first embodiment of the present invention. In FIG. 1, the same reference numerals as in FIG. 25 denote the same parts, and a repetitive description thereof will be omitted.

In FIG. 1, a digital camera 300 according to this embodiment newly comprises an EEPROM 112 for storing control data received from a PC 200.

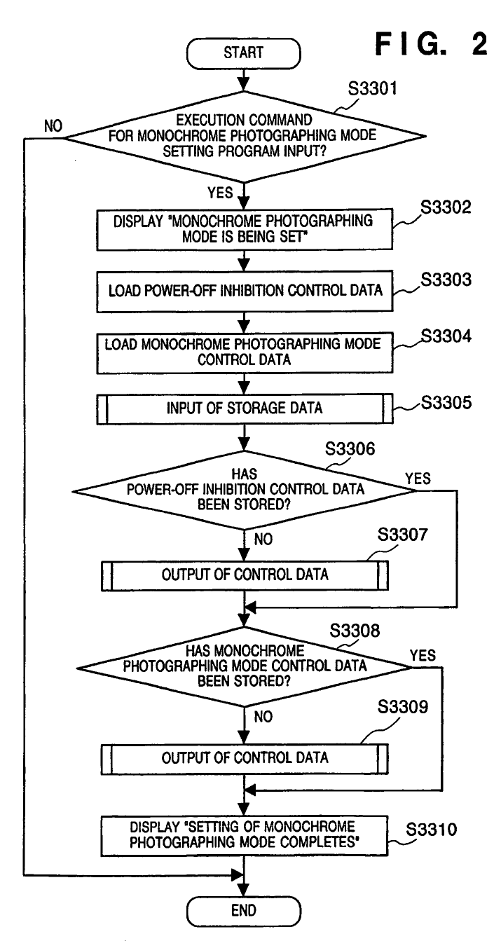

Operation of setting the monochrome photographing mode in the digital camera 300 by the PC 200 in this system will be explained with reference to FIGS. 2, 3, 4, and 5.

FIG. 2 shows the operation sequence of the PC 200 when a user inputs an execution command for a monochrome photographing mode setting program through an operation unit 206.

If the user inputs an execution command for the monochrome photographing mode setting program through the operation unit 206 in step S3301, the PC 200 displays character information “The monochrome photographing mode is being set” on a display 201 in step S3302.

An MPU 204 loads power-off inhibition control data from a hard disk 202 to a memory 203 in step S3303, and loads monochrome photographing mode control data from the hard disk 202 to the memory 203 in step S3304. In step S3305, the MPU 204 executes a storage data input subroutine in order to check whether the digital camera 300 has stored the camera power-off inhibition control data and monochrome photographing mode control data to be transmitted by the PC 200. If the digital camera 300 has already stored the control data to be transmitted, the PC 200 need not newly transmit the control data.

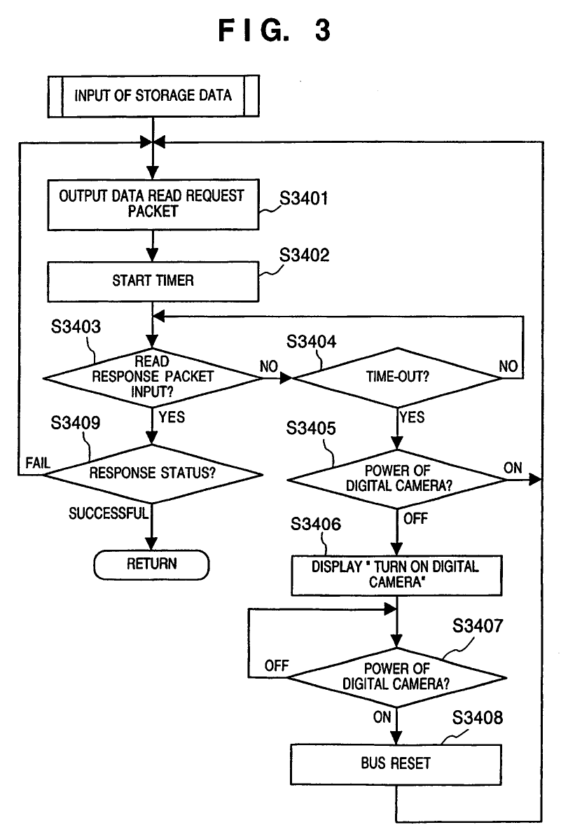

FIG. 3 shows the operation sequence of the storage data input subroutine in step S3305.

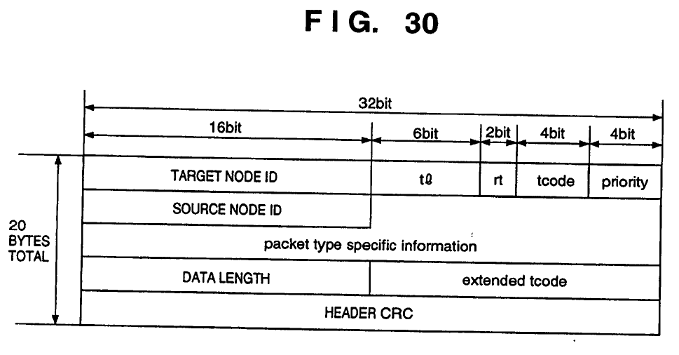

In order to input storage data from the digital camera 300 to the PC 200, the PC 200 asynchronously transfers a data read request packet like the one shown in FIG. 30 to the digital camera 300 through a 1394 serial bus cable 1. More specifically, the PC 200 outputs a data read request packet from a 1394 serial bus I/F 207 to a 1394 serial bus I/F 108 in step S3401, and starts a timer 209 in step S3402. The timer 209 detects a communication error caused by, e.g., power-off of the digital camera 300.

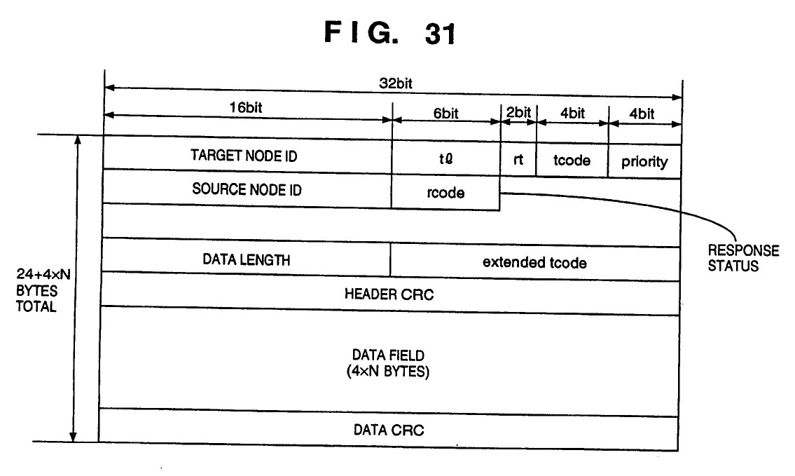

The PC 200 checks in step S3403 whether the 1394 serial bus I/F 207 receives a read response packet like the one shown in FIG. 31 from the 1394 serial bus I/F 108. If NO in step S3403, the PC 200 determines in step S3404 whether the timer 209 counts the time-out period. If NO in step S3404, the PC 200 returns to step S3403. If YES in step S3404, the PC 200 checks the power supply state of the digital camera 300 in step S3105. If the digital camera 300 is ON, the PC 200 returns to the step S3401 to restart the sequence.

If the digital camera 300 is OFF, the PC 200 displays character information “Turn on the digital camera” on the display 201 in step S3406 to prompt the user to turn on the digital camera 300. The PC 200 checks the power supply state of the digital camera 300 again in step S3407. If the digital camera 300 is OFF, the PC 200 repeats step S3407. If the user turns on the digital camera 300, bus reset occurs in the 1394 serial bus I/F 207 in step S3408. The PC 200 returns to step S3401 to restart the sequence.

If YES in step S3403, the PC 200 checks in step S3409 a response status representing whether a write of storage data is successful. If the write fails, the PC 200 returns to step S3401 to restart the sequence. If the write is successful, the storage data input subroutine ends, and the PC 200 returns to the main routine in FIG. 2.

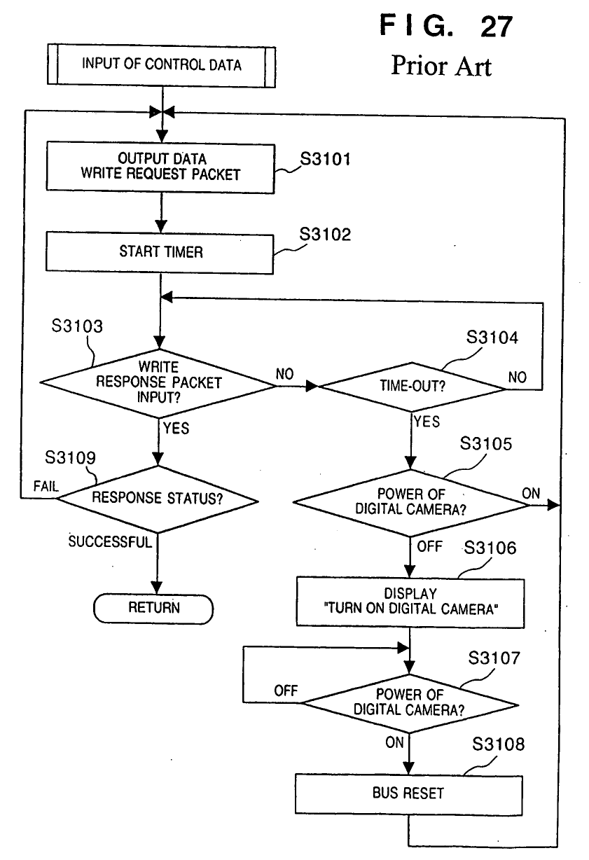

After data stored in the EEPROM 112 in the digital camera 300 is input, the PC 200 checks in step S3306 whether the power-off inhibition control data has already been stored in the EEPROM 112. If YES in step S3306, the PC 200 need not newly transmit the control data, and advances to step S3308. If NO in step S3306, the PC 200 executes the control data output subroutine shown in FIG. 27 in order to output the power-off inhibition control data from the 1394 serial bus I/F 207.

After the power-off inhibition control data is output, the PC 200 checks in step S3308 whether monochrome photographing mode control data has already been stored in the EEPROM 112. If YES in step S3308, the PC 200 need not newly transmit the control data, and advances to step S3310. If NO in step S3308, the PC 200 executes in step S3309 the control data output subroutine shown in FIG. 27 in order to output the monochrome photographing mode control data from the 1394 serial bus I/F 207. After the power-off inhibition control data and monochrome photographing mode control data are output, the PC 200 displays character information “Setting of the monochrome photographing mode is completed” on the display 201 in step S3310, and the main routine ends.

In this way, the PC 200 first transmits power-off inhibition control data before transmitting monochrome photographing mode control data. This can prevent the digital camera 300 from being automatically turned off while the PC 200 transmits the monochrome photographing mode control data to the digital camera 300.

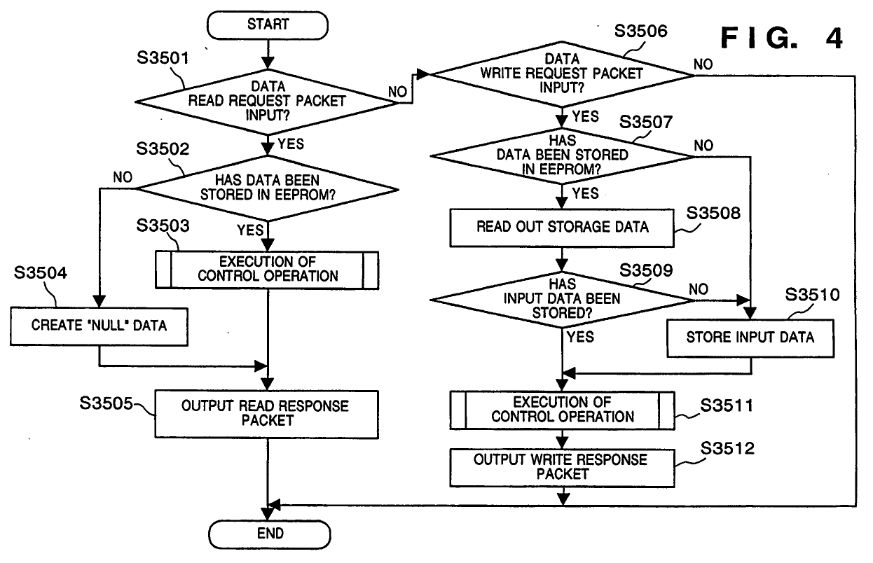

FIG. 4 shows the operation sequence of the digital camera 300 when data is input to the 1394 serial bus I/F 108. The following operation is common to all kinds of input data.

The digital camera 300 checks in step S3501 whether the 1394 serial bus I/F 108 receives a data read request packet. If NO in step S3501, the digital camera 300 shifts to step S3506. If YES in step S3501, the digital camera 300 checks in step S3502 whether the EEPROM 112 has stored control data.

If YES in step S3502, no control data is newly transmitted from the PC 200 to the digital camera 300, and thus the digital camera 300 must interpret the control data and execute control operation. For this purpose, a system controller 111 executes a control operation execution subroutine in step S3503.

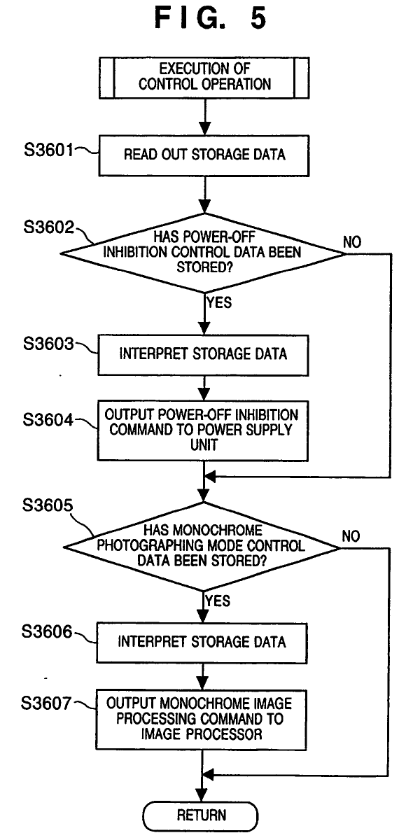

FIG. 5 shows the operation sequence of the control operation execution subroutine in step S3503.

The system controller 111 reads out the stored control data from the EEPROM 112 in step S3601, and checks in step S3602 whether power-off inhibition control data has been stored. If NO in step S3602, the system controller Ill advances to step S3605. If YES in step S3602, the system controller 111 interprets the data in step S3603, and outputs a power-off inhibition command to a power supply unit 109 in step S3604.

The system controller 111 checks in step S3605 whether monochrome photographing mode control data has been stored. If NO in step S3605, the subroutine ends. If YES in step S3605, the system controller 111 interprets the data in step S3606, outputs a monochrome image processing command to an image processor 103 in step S3607, and returns to the main routine in FIG. 4.

If NO in step S3502 of FIG. 4, the digital camera 300 creates in step S3504 “null” data informing the PC 200 that no control data is stored. In step S3505, the digital camera 300 outputs a read response packet including “storage” data or “null” data from the 1394 serial bus I/F 108 to the 1394 serial bus I/F 207, and the main routine ends.

If NO in step S3501, the digital camera 300 checks in step S3506 whether the 1394 serial bus I/F 108 receives a data write request packet. If NO in step S3506, the main routine ends. If YES in step S3506, the digital camera 300 checks in step S3507 whether the EEPROM 112 has stored control data. If NO in step S3507, the digital camera 300 shifts to step S3510 in order to store input control data.

If YES in step S3507, the digital camera 300 reads out the stored control data from the EEPROM 112 in step S3508, and checks in step S3509 whether input control data included in the write request packet has already been stored. If NO in step S3509, the digital camera 300 stores the input control data in the EEPROM 112 in step S3510. If YES in step S3509, the system controller 111 executes the control operation execution subroutine shown in FIG. 5 in step S3511 in order to interpret the control data and execute control operation.

After the system controller 111 interprets the control data and executes control operation, the system controller 111 outputs a write response packet from the 1394 serial bus I/F 108 to the 1394 serial bus I/F 207 in step S3512.

As described above, the digital camera 300 stores control data received from the PC 200 in the EEPROM 112. Even if the battery discharges by a predetermined amount or more to turn off the digital camera 300, the digital camera 300 can hold control data transmitted by the PC 200 before the digital camera 300 is turned off.

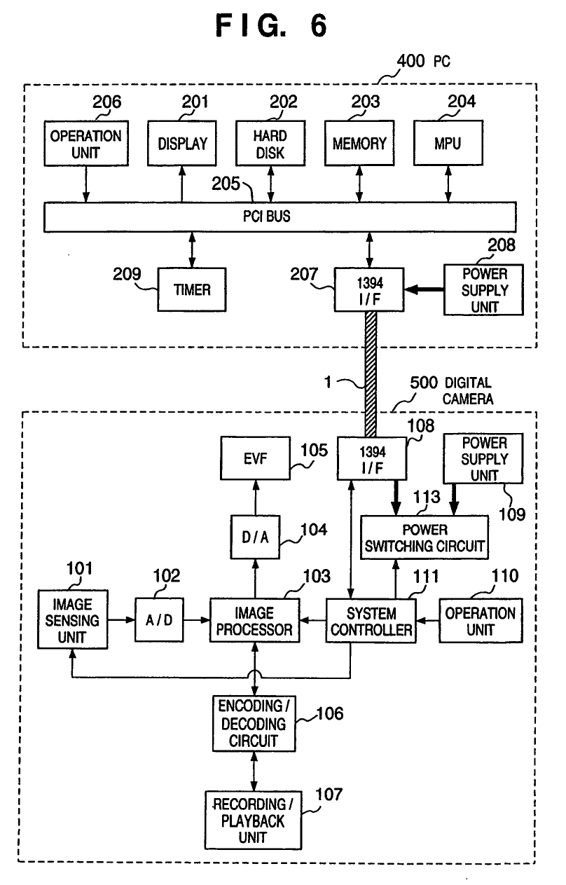

FIG. 6 shows the configuration of a camera control system using a 1394 serial bus according to the second embodiment of the present invention. In FIG. 6, the same reference numerals as in FIGS. 1 and 25 denote the same parts, and a repetitive description thereof will be omitted.

A PC 400 newly outputs a power signal from a power supply unit 208 to a 1394 serial bus I/F 207 so as to supply power to a digital camera 500 via a 1394 serial bus cable 1.

The digital camera 500 newly comprises a power switching circuit 113 for switching between an external power supply and its own power supply using a power supply unit 109. The digital camera 500 switches between a power signal from a 1394 serial bus I/F 108 and a power signal from the power supply unit 109 in accordance with a system controller command.

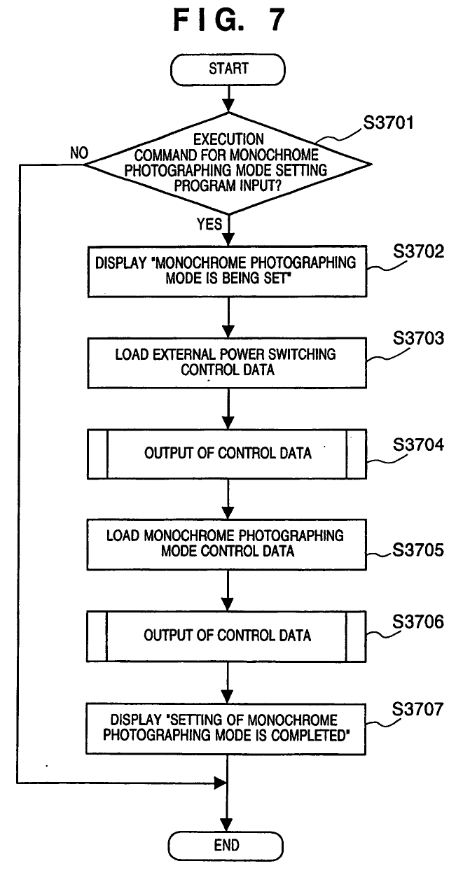

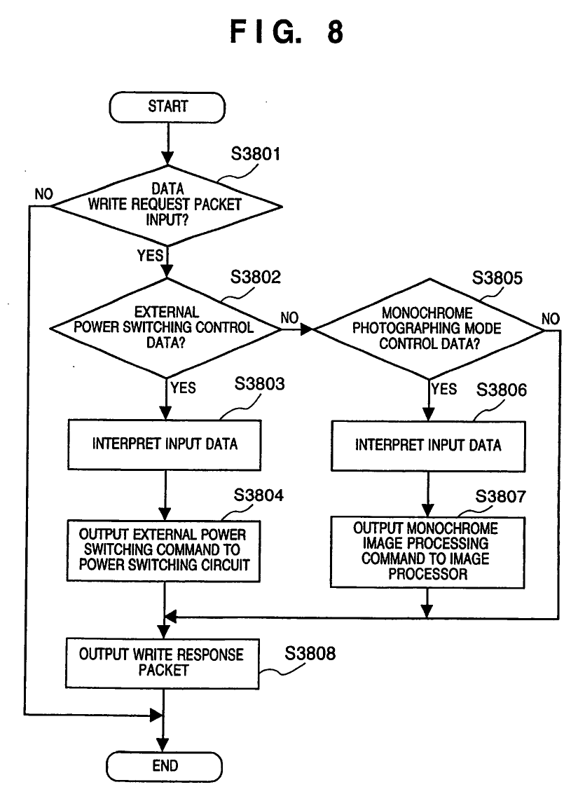

Operation of setting the monochrome photographing mode in the digital camera 500 by the PC 400 in this system will be explained with reference to FIGS. 7 and 8.

FIG. 7 shows the operation sequence of the PC 400 when a user inputs an execution command for a monochrome photographing mode setting program through an operation unit 206.

If the user inputs an execution command for the monochrome photographing mode setting program through the operation unit 206 in step S3701, the PC 400 displays character information “The monochrome photographing mode is being set” on a display 201 in step S3702.

An MPU 204 loads external power switching control data from a hard disk 202 to a memory 203 in step S3703, and executes the control data output subroutine shown in FIG. 27 in order to output the external power switching control data from the 1394 serial bus I/F 207. After the external power switching control data is output, the MPU 204 loads monochrome photographing mode setting control data from the hard disk 202 to the memory 203 in step S3705, and executes the control data output subroutine shown in FIG. 27 in step S3706 in order to output the monochrome photographing mode setting control data from the 1394 serial bus I/F 207.

After the monochrome photographing mode setting control data is output, the PC 400 displays character information “Setting of the monochrome photographing mode is completed” on the display 201 in step S3707, and the routine ends.

In this fashion, the PC 400 supplies power to the digital camera 500 through the 1394 serial bus cable 1, and transmits external power switching control data before transmitting monochrome photographing mode control data. This makes it possible to operate the digital camera 500 by external power supplied from the PC 400 while the PC 400 transmits the monochrome photographing mode control data to the digital camera 500.

FIG. 8 shows the operation sequence of the digital camera 500 when data is input to the 1394 serial bus I/F 108. The following operation is common to all kinds of input data.

If the 1394 serial bus I/F 108 receives a data write request packet in step S3801, the digital camera 500 checks in step S3802 whether the input data is external power switching control data. If YES in step S3802, the digital camera 500 interprets the data in step S3803, outputs to the power switching circuit 113 a command for switching the power signal to one from the 1394 serial bus I/F 108 in step S3804, and advances to step S3808.

If NO in step S3802, the digital camera 500 checks in step S3805 whether the input data is monochrome photographing mode control data. If NO in step S3805, the digital camera 500 shifts to step S3808. If YES in step S3805, the digital camera 500 interprets the data in step S3806, and outputs a monochrome image processing command to the image processor 103 in step S3807. In step S3808, the digital camera 500 outputs a write response packet from the 1394 serial bus I/F 108 to the 1394 serial bus I/F 207 in step S3808.

As described above, when the digital camera 500 receives external power switching control data from the PC 400, the power switching circuit 113 switches its own power supply to the external power supply. This can prevent the digital camera 500 from being turned off while the PC 400 transmits monochrome photographing mode control data to the digital camera 500.

A storage medium according to still another embodiment of the present invention will be described.

The present invention may be constituted by hardware or a computer system made up of a CPU and memory. When the present invention is constituted by the computer system, the memory constitutes a storage medium according to the present invention.

That is, the object of the present invention is achieved by using in a system or apparatus a storage medium storing software program codes for executing the operation described in each flow chart of each embodiment, and causing the CPU of the system or apparatus to read out and execute the program codes stored in the storage medium.

As a storage medium, a semiconductor memory such as a ROM or RAM, optical disk, magnetooptical disk, magnetic medium, and the like may be used. These media may be formed into a CD-ROM, floppy disk, magnetic medium, magnetic card, nonvolatile memory card, and the like.

Such storage medium may be used in another system or apparatus other than the system or apparatus shown in FIG. 1 or 6, and the system or computer may read out and execute program codes stored in the storage medium. Also in this case, the same functions as those of the above embodiments can be realized, the same effects can be obtained, and the object of the present invention can be achieved.

For example, the OS running on the computer may perform part or all of processing. Alternatively, the program codes read out from the storage medium may be written in the memory of a function expansion board inserted into the computer or a function expansion unit connected to the computer, and the CPU of the function expansion board or function expansion unit may perform part or all of processing on the basis of the instructions of the program codes. Also in this case, the same functions as those of the above embodiments can be realized, the same effects can be obtained, and the object of the present invention can be achieved.

As has been described above, according to the present invention, a communication system such as a camera control system obtained by connecting an electronic apparatus such as a camera to a control apparatus such as a PC using a communication medium such as a 1394 serial bus can transmit control information without turning off the electronic apparatus while the control apparatus transmits the control information to the electronic apparatus. The control information can be efficiently transmitted from the control apparatus to the electronic apparatus within a short time.

The control information transmitted from the control apparatus to the electronic apparatus is stored. Even if the battery discharges by a predetermined amount or more to turn off the electronic apparatus during transmission of the control information, the control apparatus transmits only untransmitted control information to the electronic apparatus after the electronic apparatus is turned on again. Thus, the control information can be efficiently transmitted from the control apparatus to the electronic apparatus.

According to the present invention, a communication system such as a camera control system obtained by connecting an electronic apparatus such as a camera to a control apparatus such as a PC using a communication medium such as a 1394 serial bus supplies power from the control apparatus to the electronic apparatus. This can prevent the electronic apparatus from being turned off during transmission of the control information. Therefore, the control information can be efficiently transmitted from the control apparatus to the electronic apparatus within a short time.

The present invention is not limited to the above embodiments and various changes and modifications can be made within the spirit and scope of the present invention. Therefore, to apprise the public of the scope of the present invention the following claims are made.

1-26. (canceled)

27. A communication system comprising an electronic apparatus having a first communication means and a control apparatus having a second communication means capable of being connected to the first communication means through a communication medium, said control apparatus having transmission means for transmitting, through the communication medium, a program to a program memory in said electronic apparatus for causing said electronic apparatus to execute a predetermined operation,
wherein said control apparatus comprises power supply means for supplying an electric power to said electronic apparatus through the communication medium,
the transmission means transmits switching control information concerning switching operation of a power source to the electronic apparatus before a transmission of the program in the case that the transmission means transmits said program to said program memory in said electronic apparatus, and said electronic apparatus comprises switching means for switching a power source from a power supply in said electronic apparatus to the power supply means in said control apparatus based on the switching control information.

28. The system according to claim 27, wherein said electronic apparatus comprises storage means for storing the switching control information.

29. The system according to claim 27 or 28, wherein said electronic apparatus comprises a camera apparatus.

30. The system according to claim 27 or 28, wherein said control apparatus comprises a personal computer.

31. The system according to claim 27 or 28, wherein the communication medium comprises a 1394 serial bus.

32. An electronic apparatus comprising:
communication means capable of being connected to a control apparatus through a communication medium;
control means for executing a control operation based on a predetermined program stored in a program memory in said electronic apparatus, wherein said program is transmitted from the control apparatus through the communication medium; and
switching means for power switching a power source from a power supply of the electronic apparatus to an electric power transmitted from the control apparatus through the communication medium based on switching control information transmitted through the communication medium before reception of the program in the case that the electronic apparatus receives the predetermined program to be loaded in said program memory in said electronic apparatus from the control apparatus.

33. A control apparatus comprising:
communication means capable of being connected to an electronic apparatus through a communication medium;
power supply means for supplying an electric power to said electronic apparatus through the communication medium; and
transmission means for transmitting switching control information for switching a power source from a power supply in the electronic apparatus to the power supply means in said control apparatus through the communication medium before a transmission of a program for controlling the electronic apparatus to a program memory in said electronic apparatus in the case that the transmission means transmits the program to said memory in said electronic apparatus.

34. A communication method comprising:
a program transmission step of transmitting a program for controlling an electronic apparatus to a program memory in the electronic apparatus through a communication medium;
power supply step of supplying an electric power to the electronic apparatus through the communication medium; and
switching step of transmitting control information for switching a power source from a power supply in the electronic apparatus to the electric power supplied in the power supply step through the communication medium before the start of the program transmission step in the case that the program transmission step for transmitting the program to said program memory in said electronic apparatus is executed.

35. A computer readable storage medium storing a program for executing the communication method according to claim 34.
